(19) United States
(12) Patent Application Publication
(10) Pub. No.: US 2024/0353032 A1
(43) Pub. Date: Oct. 24, 2024

(54) ADJUSTABLE MESSENGER CABLE CLAMP

(71) Applicant: SHOALS TECHNOLOGIES GROUP, LLC, Portland, TN (US)

(72) Inventor: Paul E. ATTEA, Portland, TN (US)

(21) Appl. No.: 18/641,099

(22) Filed: Apr. 19, 2024

Related U.S. Application Data
(60) Provisional application No. 63/497,408, filed on Apr. 20, 2023.

(51) Int. Cl. F16L 3/24; F16L 3/12

(52) U.S. Cl. CPC F16L 3/24; F16L 3/1211

(57) ABSTRACT

A messenger cable clamp includes an elongate clamp beam, a clamp clip, and multiple fasteners. The clamp clip defines at least a first clip fastener opening and a second clip fastener opening. The fasteners include at least a first fastener and a second fastener. The first fastener includes a first portion configured to pass through the first clip fastener opening in the clamp clip. The second fastener includes a second portion configured to pass through the second clip fastener opening in the clamp clip. At least one of the first or second fasteners is configured to cooperate with one or both of the clamp clip or the elongate clamp beam to clamp the messenger cable clamp to the structural element.

### CROSS-REFERENCE TO RELATED APPLICATION

This application claims the benefit of and priority to U.S. Provisional App. No. 63/497,408 filed Apr. 20, 2023, which is incorporated herein by reference in its entirety.

### FIELD

The embodiments discussed in the present disclosure are related to solar energy systems and, more particularly, adjustable PV pile clamps for use in solar energy systems.

### BACKGROUND

Solar power has long been considered a niche utility. It is considered desirable from an environmental and political standpoint, but perhaps not economically feasible for generating enough power to make a meaningful contribution to the grid. However, as the problems associated with our dependence on fossil fuels have become better understood, more attention has been paid to so-called alternative energy such as solar power. This attention has led to significant technological and policy advances, such that solar power is now quite prevalent, and more economically feasible.

Technological advances in the generation of solar energy have occurred in multiple areas, including collector material and structure, and wiring infrastructure. Wiring infrastructure, however, continues to present challenges, particularly in large scale solar photovoltaic (PV) panel array installations. Proper wire management is vital to the health of the PV system. Damaged wire insulation can lead to ground-faults, system downtime and fire. Moreover, PV systems are installed in various geographic locations, and experience extreme weather and environmental conditions. The wiring infrastructure must defy wind and weather conditions for many years and must reliably safeguard various electricity yields. The sheer number of cables associated with a typical PV array installation adds to the difficulty in providing efficient and effective wire management. The cables employed to convey electricity to or from a PV system may be referred to as electrical cables.

Long cable runs between structural elements (e.g., structural piles) can put a significant structural strain on the electrical cables if the electrical cables support their own weight. To avoid such strain on the electrical cables, messenger cable (or messenger wire) may be used essentially as a backbone to support the electrical cables. For example, the messenger cable may extend between structural elements with the electrical cables suspended from the messenger cable at numerous locations between the structural elements to reduce mechanical strain at any one location of the electrical cables.

Messenger cable brackets are used to suspend messenger cables from the PV system, and particularly from structural elements such as structural piles. The messenger cable brackets are typically fastened to the structural elements using bolts that require field drilling of holes in the structural elements. This often involves first drilling a pilot hole in the structural element using a relatively small diameter drill bit followed by drilling a larger diameter through hole in the structural element at the location of the pilot hole using a larger diameter drill bit. For a large PV array, there may be hundreds of holes drilled. The drilling of holes (including both pilot holes and their corresponding larger diameter through holes) adds labor costs, time, and tooling to the construction of PV arrays.

Accordingly, there is a need for improved methods and devices to couple messenger cable brackets to PV system structural elements that cost less labor, time, and/or tooling than existing solutions.

The subject matter claimed in the present disclosure is not limited to embodiments that solve any disadvantages or that operate only in environments such as those described above. Rather, this background is only provided to illustrate one example technology area where some embodiments described in the present disclosure may be practiced.

### SUMMARY

This Summary is provided to introduce a selection of concepts in a simplified form that are further described below in the Detailed Description. This Summary is not intended to identify key features or essential characteristics of the claimed subject matter, nor is it intended to be used to limit the scope of the claimed subject matter.

Some embodiments of the present disclosure address the problems experienced in other PV systems in which messenger cable brackets are fastened to structural elements of the PV system using bolts that require field drilling of holes in the structural elements. Disclosed embodiments address such issues by providing messenger cable clamps to support messenger cables, where the messenger cable clamps clamp to structural elements of the PV system without requiring any drilling of the structural elements, e.g., drilling of pilot holes and through holes. Such messenger cable clamps may implement fasteners that do not pass through any portion of the structural elements of the PV system.

Such messenger cable clamps may generally include an elongate clamp beam, one or more clamp clips, and one or more fasteners that cooperate to clamp the messenger cable clamp to a structural element of a solar infrastructure.

An example embodiment of such a messenger cable clamp includes an elongate clamp beam, a clamp clip, and multiple fasteners. The clamp clip defines at least a first clip fastener opening and a second clip fastener opening. The fasteners include at least a first fastener and a second fastener. The first fastener includes a first portion configured to pass through the first clip fastener opening in the clamp clip. The second fastener includes a second portion configured to pass through the second clip fastener opening in the clamp clip. At least one of the first or second fasteners is configured to cooperate with one or both of the clamp clip or the elongate clamp beam to clamp the messenger cable clamp to a structural element of solar infrastructure.

Another example embodiment of such a messenger cable clamp includes an elongate clamp beam, a clamp clip, and a fastener. The elongate clamp beam defines multiple openings, the elongate clamp beam having a cross-sectional shape in a plane perpendicular to a length of the elongate clamp beam. The clamp clip defines a beam opening having a shape that encompasses the cross-sectional shape of the elongate clamp beam. The elongate clamp beam is configured to be positioned within the beam opening of the clamp clip, the clamp clip further defining a fastener opening. The fastener includes a first end (e.g., a hooked end) configured to engage a structural element of a solar infrastructure and an opposing second end configured to pass through the fastener opening of the clamp clip. The fastener is configured to cooperate with one or both of the clamp clip or the elongate clamp beam to clamp the messenger cable clamp to the structural element without passing through the structural element.

Some embodiments of the messenger cable clamps herein may be adaptable to clamp to a variety of different-shaped components of the solar infrastructure and/or in two or more orientations relative to the components. Some embodiments herein may be quickly clamped to solar infrastructure in any of two or more orientations, providing case of installation. Movement resistance of some messenger cable clamps herein may be maintained by three points of contact between the messenger cable clamp and the structural element. Alternatively or additionally, such messenger cable clamps may exploit rotational force exerted by the messenger cable load to further secure the messenger cable clamp to the structural element. In some embodiments, electrical bonding of a grounding wire to the structural element may be implemented using a ring terminal or other suitable terminal at any hardware points of the messenger cable clamp (e.g., threaded fastener(s) such as self-tapping screws).

The object and advantages of the embodiments will be realized and achieved at least by the elements, features, and combinations particularly pointed out in the claims. Both the foregoing summary and the following detailed description are exemplary and explanatory and are not restrictive.

### BRIEF DESCRIPTION OF THE DRAWINGS

Example embodiments will be described and explained with additional specificity and detail through the use of the accompanying drawings in which:

FIG. 1 shows an example solar infrastructure;

FIGS. 2A-2E illustrate an example messenger cable clamp clamped to an example pile to support an example messenger cable;

FIGS. 3A-3E illustrate another example messenger cable clamped to an example pile to support an example messenger cable;

FIGS. 4A-4E illustrate another example messenger cable clamped to an example pile to support an example messenger cable;

FIGS. 5A-5B illustrate another example messenger cable clamp clamped to an example pile to support an example messenger cable; and

FIGS. 6A-6E illustrate another example messenger cable clamped to an example pile to support an example messenger cable, all according to at least one embodiment described in the present disclosure.

### DETAILED DESCRIPTION

Embodiments of the present disclosure will be explained with reference to the accompanying figures. It is to be understood that the figures are diagrammatic and schematic representations of such example embodiments, and are not limiting, nor are they necessarily drawn to scale. In the figures, features with like numbers indicate like structure and function unless described otherwise.

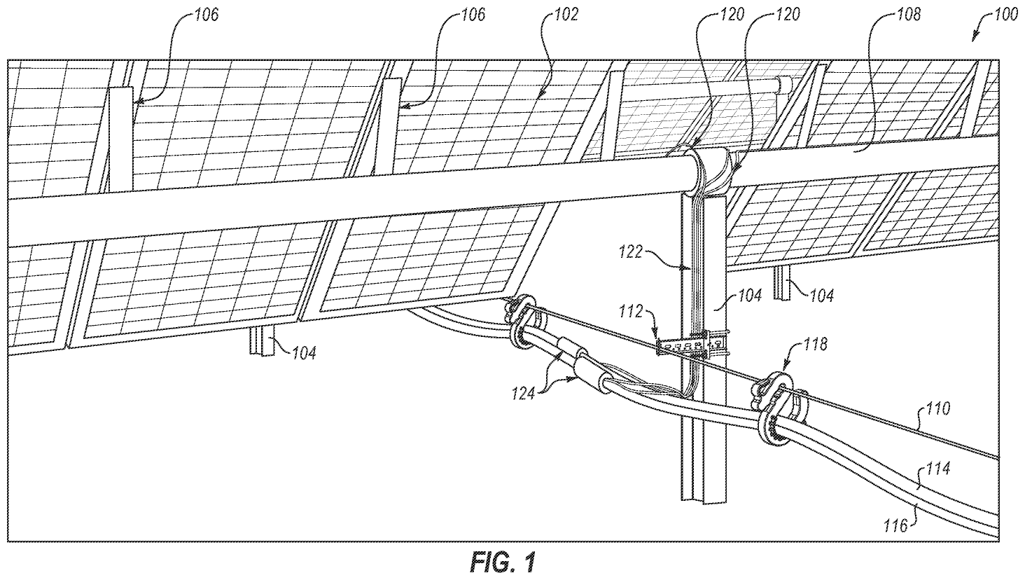

FIG. 1 shows an example solar infrastructure 100, arranged in accordance with at least one embodiment herein. As illustrated, the solar infrastructure 100 supports multiple solar panels 102 using piles 104 of the solar infrastructure 100. In particular, the solar panels 102 are mounted to frames 106, the frames 106 are mounted to and supported by support tubes 108, and the support tubes 108 are mounted to and supported by the piles 104 for an above ground installation, the frames 106 and support tubes 108 being part of the solar infrastructure 100. The piles 104 may be installed in, on, coupled to, etc. the ground or other surface, structure, or the like. The pile 104 is illustrated as an I-pile or H-pile (e.g., a pile having a cross-section perpendicular to its length in the shape of an I or H with two parallel flanges coupled by a web) but a round pile (e.g., a pile having a cross-section perpendicular to its length in the shape of a circle, ellipse, or the like), an octagonal pile (e.g., a pile having a cross-section perpendicular to its length in the shape of an octagon), or other pile may be used.

The solar infrastructure 100 additionally includes a messenger cable or wire 110 mounted via a messenger cable clamp 112 to the pile 104. One or more big lead assembly (BLA) cables (e.g., a positive BLA cable and a negative BLA cable) 114, 116 or other cables or wires hang from the messenger cable 110. A cable hanger 118 is shown to hang from the messenger cable 110 to carry the BLA cables 114, 116. BLA cables 114, 116 may be trunk cables or lead cables that carry the electricity from a group of solar panels 102 to a central component. The BLA cables 114, 116 are suspended from the messenger cable 110. A first branch cable 120 (e.g., positive) and a second branch cable 122 (e.g., negative) run between the solar panel 102 and the BLAs 114, 116 and electrically couple the solar panel 102 to the BLAs 114, 116. Junction connectors 124 connect the first branch cable 120 to the BLA cable 116 and the second branch cable 122 to the BLA cable 114.

As shown, the messenger cable 110 structurally supports the BLA cables 114, 116, e.g., to reduce mechanical stress or strain on the BLA cables 114, 116. Some embodiments herein provide a messenger cable clamp (e.g., messenger cable clamp 112) that can be used in the solar infrastructure 100 to, e.g., suspend a messenger cable (e.g., messenger cable 110) from a pile (e.g., pile 104) or other structural element of the solar infrastructure 100.

Some other solutions for coupling messenger cable to a solar infrastructure use messenger cable brackets. Such messenger cable brackets are typically fastened to the solar infrastructure, e.g., the pile 104, using bolts that require field drilling of holes in the solar infrastructure. This often involves first drilling a pilot hole in the solar infrastructure using a relatively small diameter drill bit followed by drilling a larger diameter through hole in the solar infrastructure element at the location of the pilot hole using a larger diameter drill bit. For a large PV array, there may be hundreds of holes drilled. The drilling of holes (including both pilot holes and their corresponding larger diameter through holes) adds labor costs, time, and tooling to the construction of PV arrays.

To address these and other problems, some embodiments described in the present disclosure may implement a messenger cable clamp (e.g., instead of a messenger cable bracket), such as the messenger cable clamp 112, that clamps to solar infrastructure, such as the pile 104 of the solar infrastructure 100, to support a messenger cable, such as the messenger cable 110, without drilling any pilot holes or through holes in the solar infrastructure. Such a messenger cable clamp may generally include an elongate clamp beam, one or more clamp clips, and one or more fasteners that cooperate to clamp the messenger cable clamp to the solar infrastructure. In some embodiments, the various components of the messenger cable clamp may be adaptable to clamp to a variety of different-shaped components of the solar infrastructure and/or in two or more orientations relative to the components. Embodiments herein may be quickly clamped to solar infrastructure in any of two or more orientations, providing ease of installation. Movement resistance of the messenger cable clamp may be maintained by three points of contact with the solar infrastructure. Alternatively or additionally, the messenger cable clamp may exploit rotational force exerted by the messenger cable load to further secure the messenger cable clamp to the solar infrastructure. In some embodiments, electrical bonding of a grounding wire to the solar infrastructure may be implemented using a ring terminal or other suitable terminal at any hardware points of the messenger cable clamp (e.g., threaded fastener(s) such as self-tapping screws).

As already indicated, some embodiments of the messenger cable clamp herein may include an elongate clamp beam, one or more clamp clips, and one or more fasteners. The elongate clamp beam may define multiple openings and may have a cross-sectional shape in a plane perpendicular to a length of the elongate clamp beam. The clamp clip may define a beam opening having a shape that encompasses the cross-sectional shape of the elongate clamp beam. The elongate clamp beam may be configured to be positioned within the beam opening of the clamp clip. The clamp clip may further define a fastener opening. The fastener may include a first end configured to engage a solar infrastructure and an opposing second end configured to pass through the fastener opening of the clamp clip. The fastener may be configured to cooperate with one or both of the clamp clip or the elongate clamp beam to clamp the messenger cable clamp to the solar infrastructure without passing through the solar infrastructure, thereby eliminating any drilling of the solar infrastructure to install the messenger cable clamp.

In some embodiments, a messenger cable clamp includes an elongate clamp beam, a clamp clip, and multiple fasteners. The elongate clamp beam may define at least a first beam fastener opening and a second beam fastener opening. The clamp clip may define at least a first clip fastener opening and a second clip fastener opening. The fasteners may include at least a first fastener and a second fastener. The first fastener may include a first portion configured to pass through both the first beam fastener opening in the elongate clamp beam and the first clip fastener opening in the clamp clip. The second fastener may include a second portion configured to pass through both the second beam fastener opening in the elongate clamp beam and the second clip fastener opening in the clamp clip. At least one of the first or second fasteners may be configured to cooperate with the clamp clip to clamp the messenger cable clamp to the solar infrastructure.

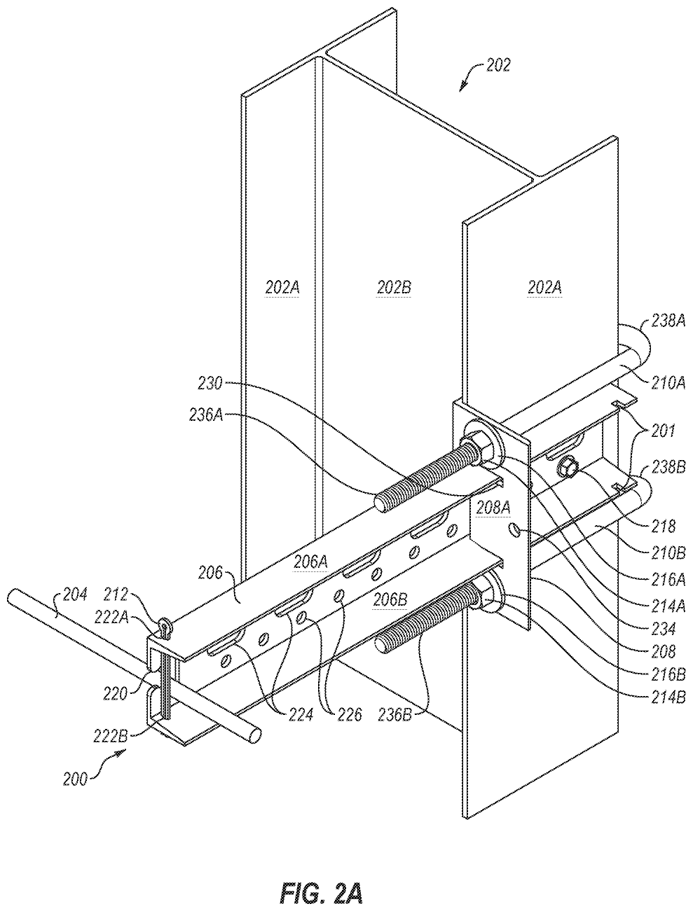

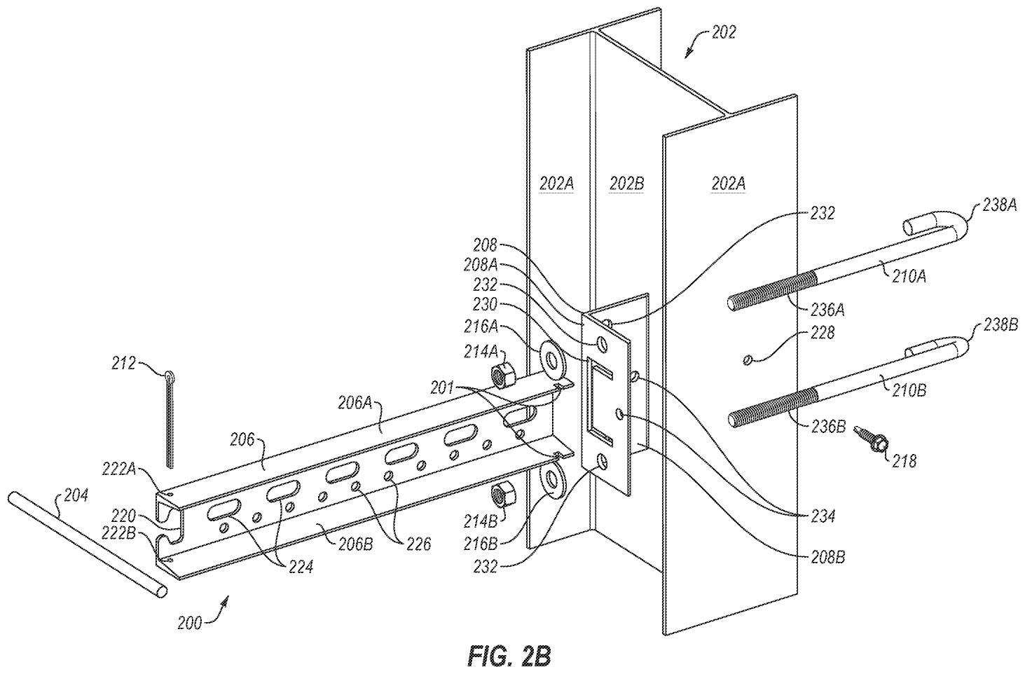

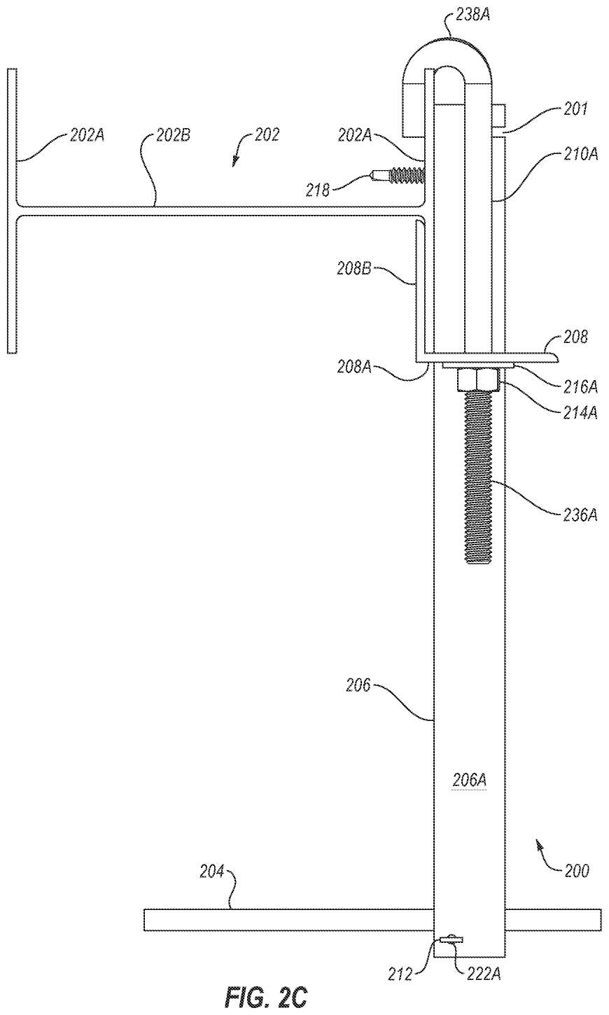

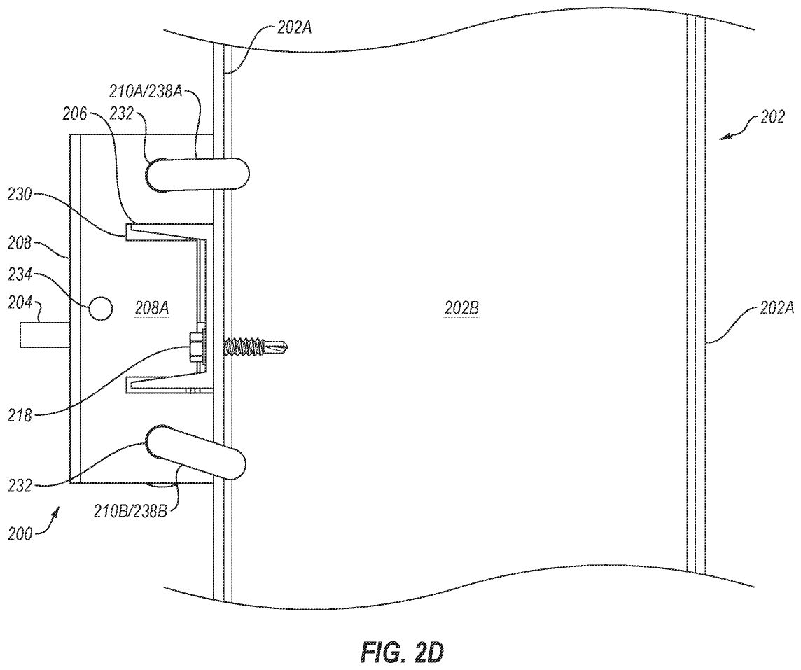

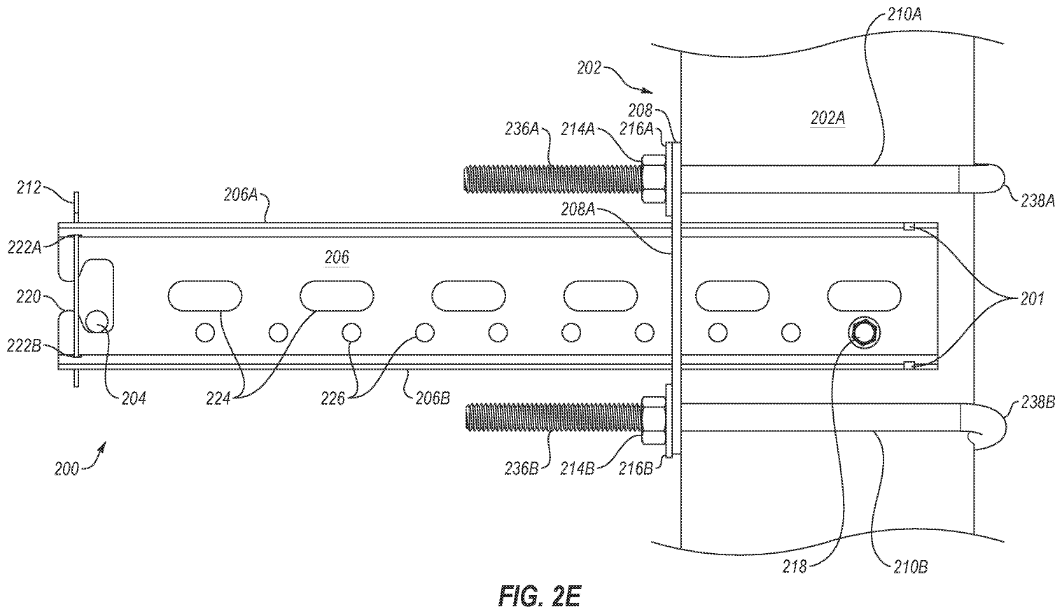

Various specific embodiments of a messenger cable clamp that are consistent with the foregoing will now be discussed with respect to FIGS. 2A-5. Each of the following messenger cable clamps discussed with respect to FIGS. 2A-5 may be implemented in the solar infrastructure 100 of FIG. 1, e.g., instead of or in addition to the messenger cable clamp 112.

FIGS. 2A-2E illustrate an example messenger cable clamp 200 (hereinafter “clamp 200”) clamped to an example pile 202 to support an example messenger cable 204, arranged in accordance with at least one embodiment herein. FIG. 2A is a perspective view of the clamp 200, FIG. 2B is an exploded perspective view of the clamp 200, FIG. 2C is an overhead view of the clamp 200, FIG. 2D is an end view of the clamp 200, and FIG. 2E is a side view of the clamp 200.

The pile 202 is one example of solar infrastructure to which the clamp 200 may be clamped. In other embodiments, the clamp 200 may be clamped to other components of a solar infrastructure. As illustrated, the pile 202 has an I- or H-shaped cross-sectional shape. Alternatively or additionally, the pile 202 may have other shapes or configurations in other embodiments, some of which are illustrated in and described with respect to other FIGS. herein.

With combined reference to FIGS. 2A-2E, the clamp 200 includes an elongate clamp beam 206 (hereinafter “beam 206”), a clamp clip 208 (hereinafter “clip 208”), and first and second fasteners 210A, 210B (hereinafter collectively “fasteners 210” or generically “fastener 210”). In some embodiments, the clamp 200 additionally includes one or more of a pin 212, first and second nuts 214A, 214B (hereinafter collectively “nuts 214” or generically “nut 214”), first and second washers 216A, 216B (hereinafter collectively “washers 216” or generically “washer 216”), and/or a self-tapping screw 218.

In the illustrated embodiment, a distal end of the beam 206 (e.g., distal from the pile 202) defines a slot 220. The slot 220 is illustrated as a dovetail slot but may have other shapes or configurations in other embodiments. The slot 220 is configured to receive therein and support the messenger cable 204. Some embodiments further include a slot closure to close an opening of the slot 220 to retain the messenger cable 204 within the slot 220. As illustrated, the slot closure is the pin 212. Referring to FIGS. 2A and 2B, the beam 206 includes flanges 206A, 206B that together define through holes 222A, 222B (hereinafter collectively “through holes 222”). The through holes 222 are aligned to receive therethrough the pin 212. The pin 212 may have sufficient length to pass through both flanges 206A, 206B via through holes 222 to secure the opening of the slot 220 and an oversized head to prevent the pin 212 from passing all the way through the through holes 222. With the messenger cable 204 disposed in the slot 220 and the pin 212 inserted through both through holes 222, the pin 212 blocks the opening of the slot 220, thereby preventing or at least inhibiting the messenger cable 204 from being removed from the slot 220 through the opening of the slot.

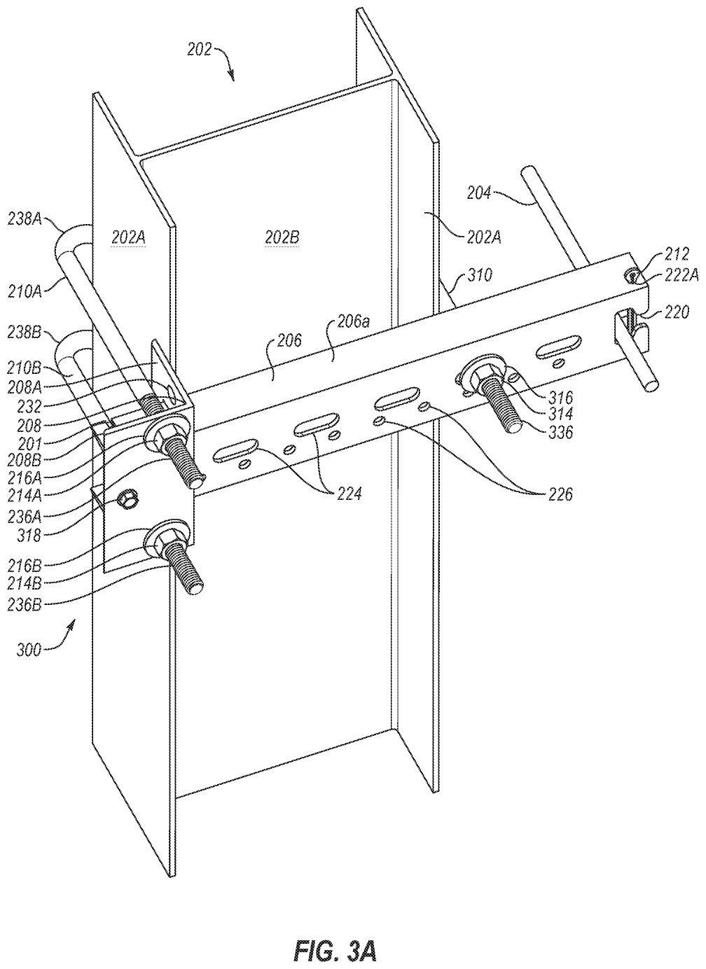

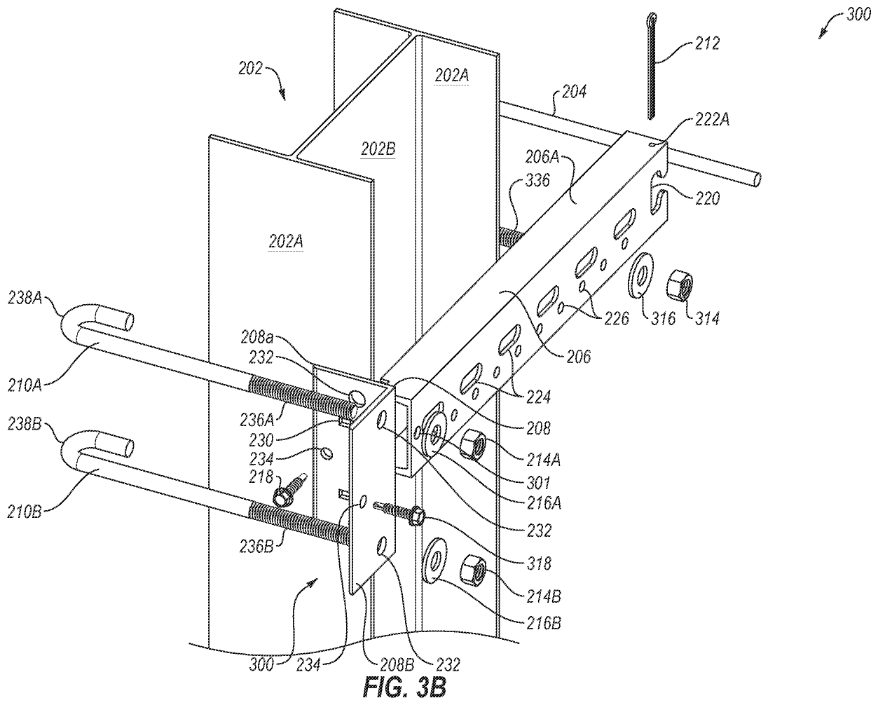

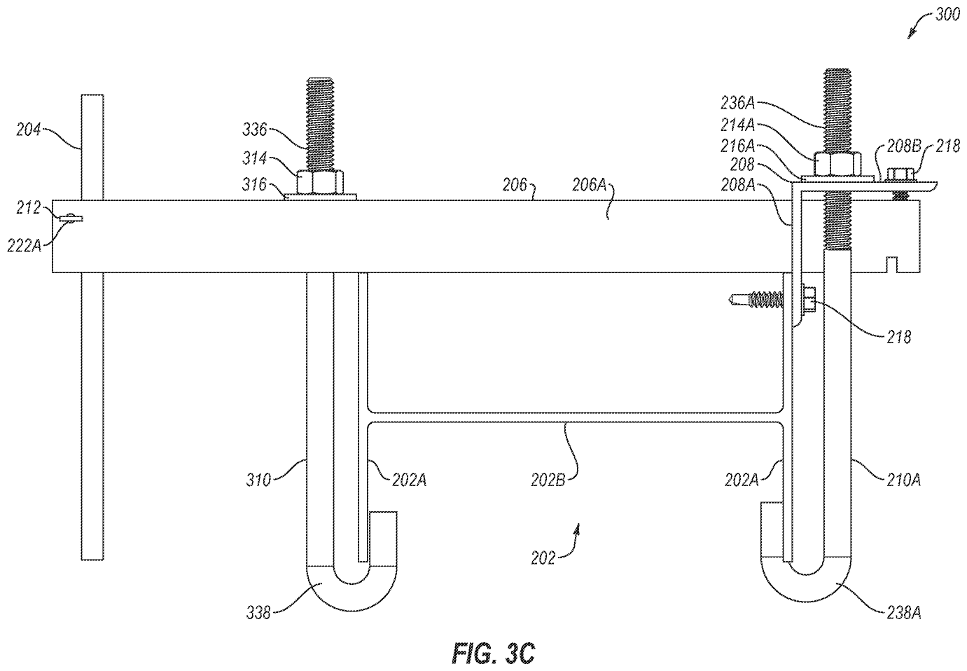

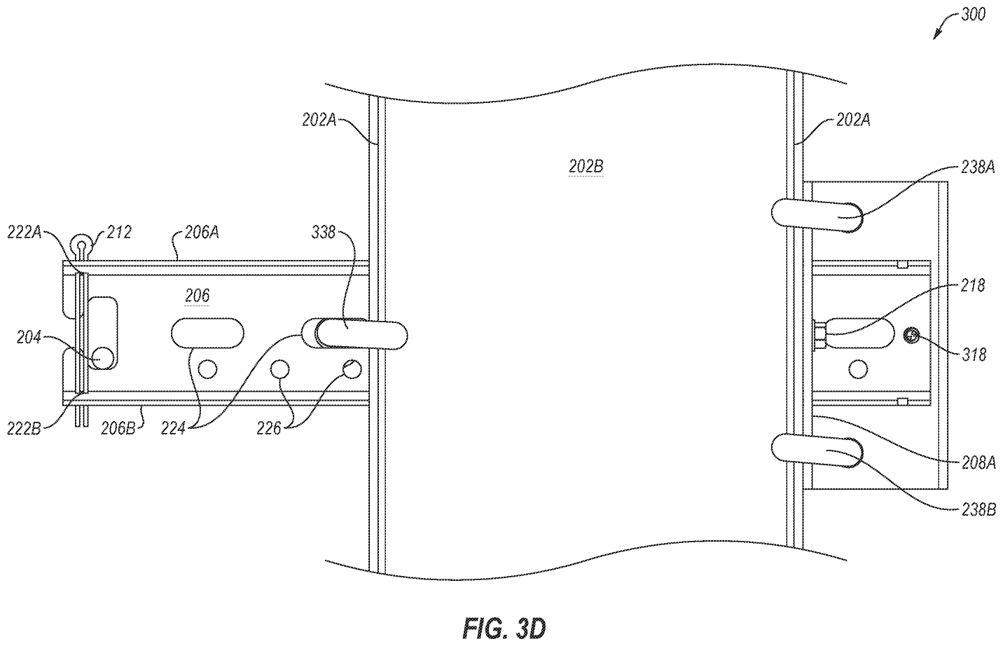

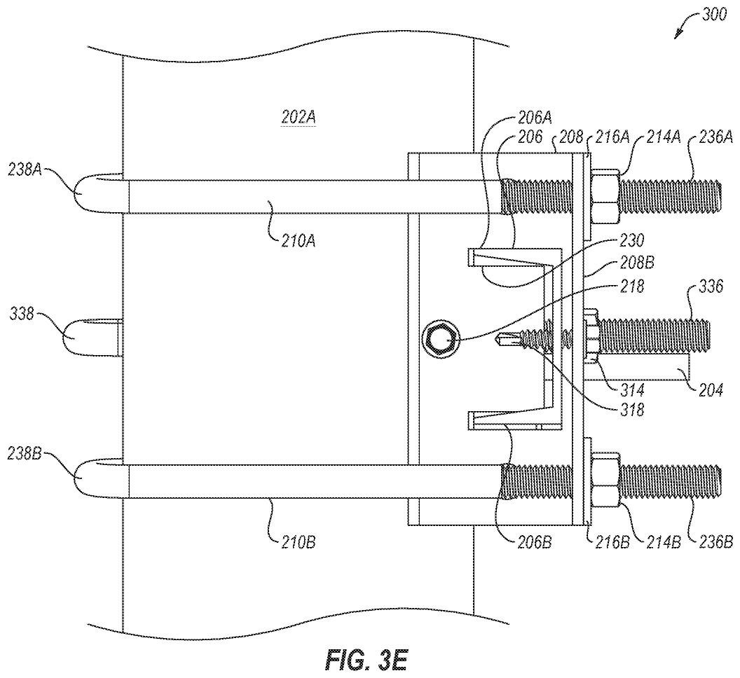

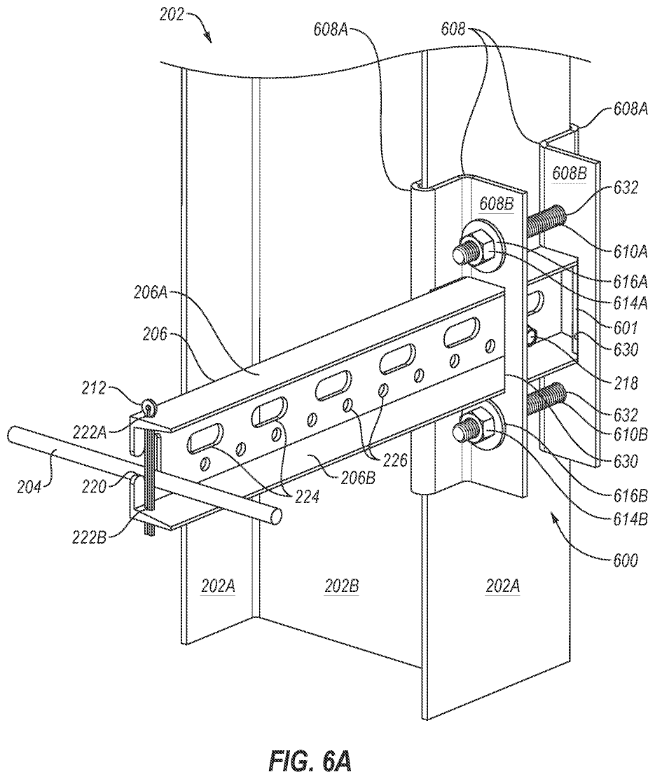

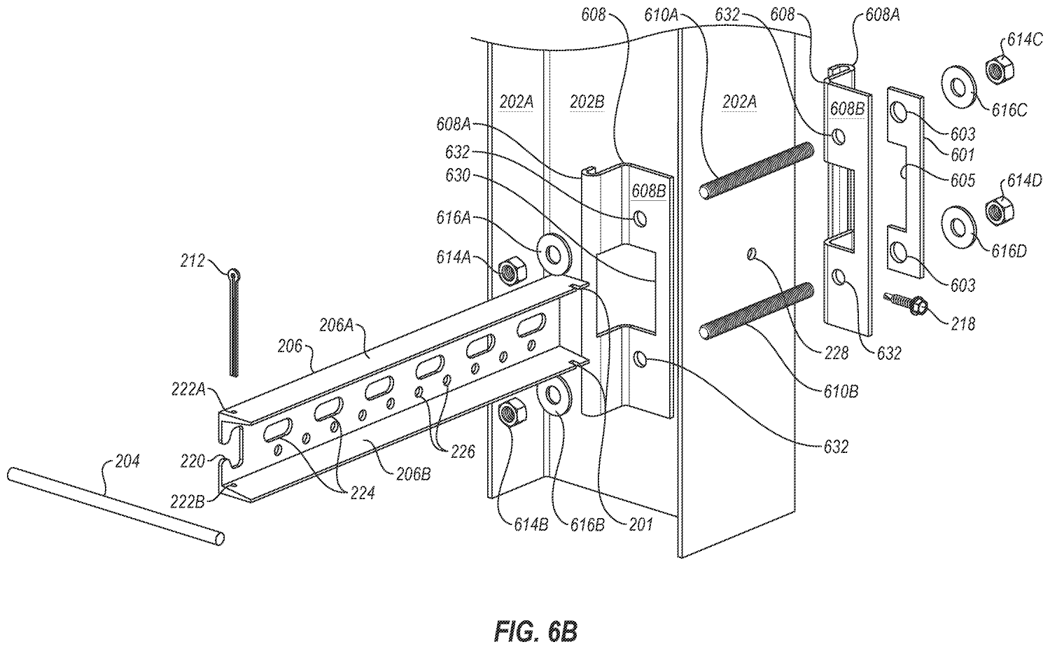

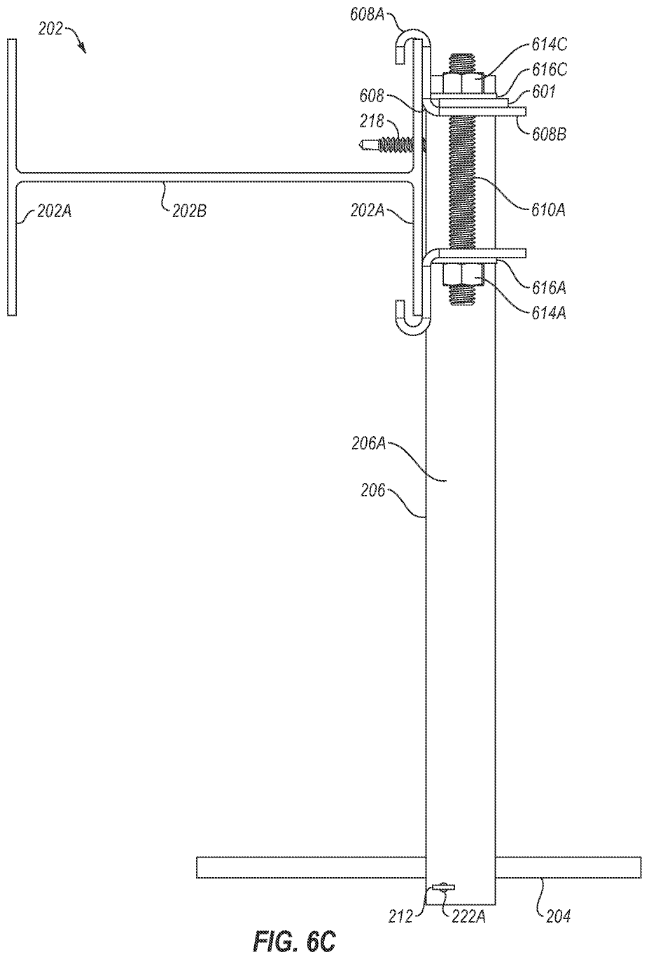

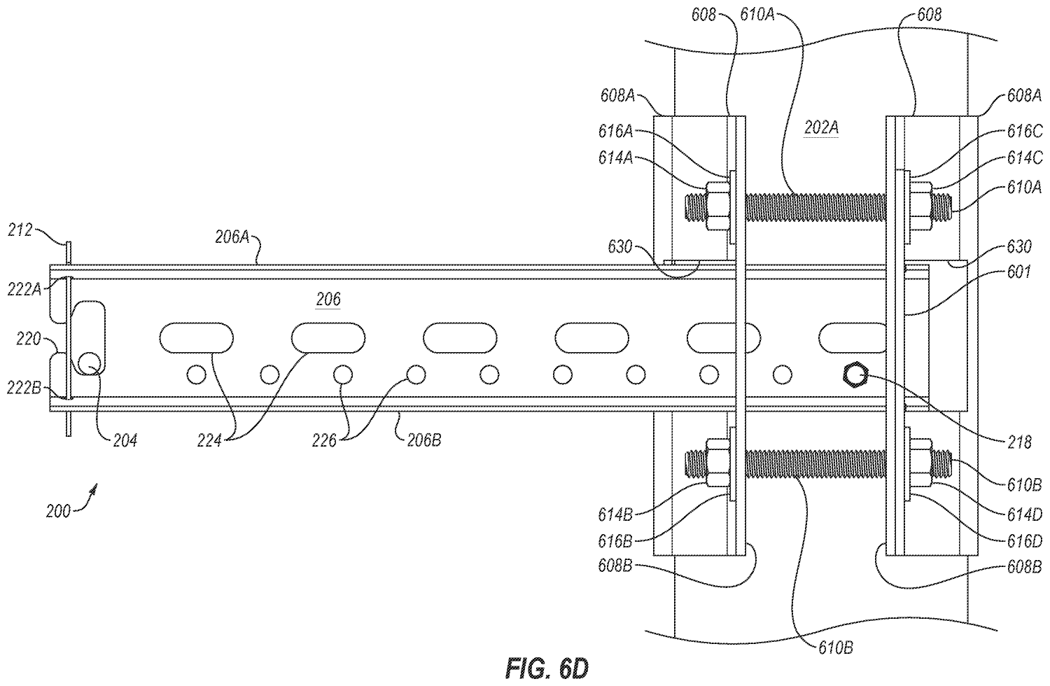

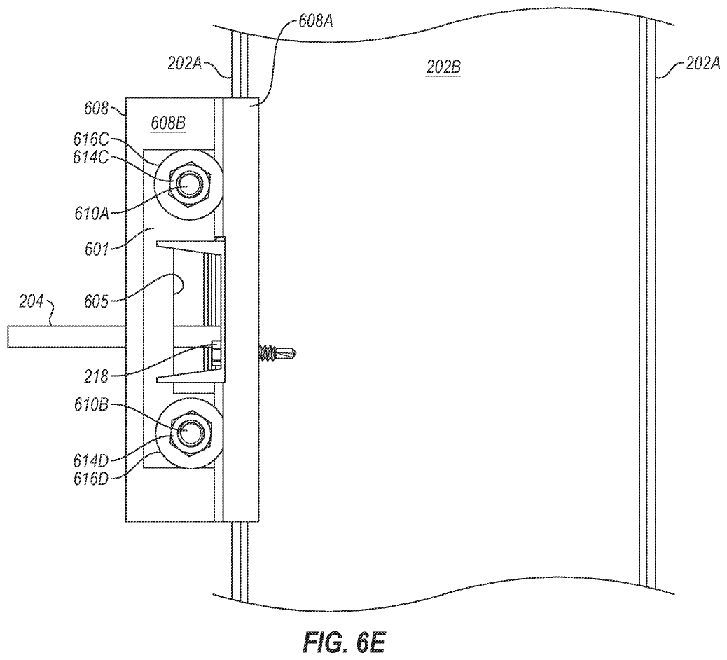

The beam 206 defines multiple openings 224, 226, only some of which are labeled in the figures for simplicity. The openings 224, 226 may have different purposes or uses. For example, the larger of the openings, i.e., openings 224, may be configured in some embodiments (e.g., FIGS. 3A-3E) to have fasteners 210 pass therethrough to secure the clamp 200 to the pile 202, although they are not used in that manner in FIGS. 2A-2E. The openings 224 may be slotted to allow some horizontal adjustability of the position of the beam 206 relative to the pile 202. In some embodiments, the smaller of the openings, i.e., the openings 226, may be configured to receive therethrough the self-tapping screw 218 (which is then coupled to the pile 202) to electrically and/or mechanically bond the beam 206 to the pile 202. FIG. 2B illustrates an example self-tapped through hole 228 that may be formed in the pile 202 by the self-tapping screw 218 to electrically and/or mechanically bond the beam 206 to the pile 202. The self-tapped through hole 228 (and other self-tapped through holes herein) is distinguishable from drilled holes discussed in, e.g., the BACKGROUND section of this application in that the self-tapped through hole 228 is made by the self-tapping screw 218 rather than by a drill bit. In some embodiments, the beam 206 further includes one or more notches 201 formed in one or both flanges 206A, 206B. An example use of the notches 201 is described below with respect to FIGS. 6A-6E.

The clip 208 may generally include an angled component made up of first and second planar portions 208A, 208B arranged perpendicular or at some other angle to each other. The first planar portion 208A of the clip 208 defines a beam opening 230 that has a shape. The shape of the beam opening 230 is configured to encompass a cross-sectional shape of the beam 206 in a plane perpendicular to a length of the beam 206. For example, as illustrated in FIG. 2D, the cross-sectional shape of the beam 206 in the plane perpendicular to the length of the beam 206 is encompassed by the cross-sectional shape of the beam opening 230. The beam opening 230 thereby substantially confines the beam 206 in a plane parallel to the web 202B of the pile 202 while permitting movement of the beam 206 relative to the clip 208 in a direction perpendicular to the web 202B of the pile 202.

In the illustrated example, the second planar portion 208B of the clip 208 wraps around one of the flanges 202A of the pile 202 and is arranged parallel to the flange 202A. The first planar portion 208A is arranged perpendicular to the flange 202A. The beam 206 is arranged with its length perpendicular to the web 202B and parallel to the flanges 202A. In this arrangement, and as best illustrated in FIG. 2C, a portion of the flange 202A is positioned between the second planar portion 208B of the clamp 208 and a portion of the beam 206. In some embodiments, the portion of the flange 202A is sandwiched between the second planar portion 208B of the clamp 208 and the portion of the beam 206.

As best seen in FIG. 2B, the clip 208 further defines multiple openings 232, 234. The openings 232, 234 may have different purposes or uses. For example, the larger of the openings, i.e., openings 232, may be configured in some embodiments to have fasteners 210 pass therethrough to secure the clamp 200 to the pile 202, as illustrated in FIGS. 2A-2E. In some embodiments, the smaller of the openings, i.e., the openings 234, may be configured to receive therethrough the self-tapping screw 218 (which is then coupled to the pile 202) to electrically and/or mechanically bond the clip 208 to the pile 202 although they are not used in that manner in FIGS. 2A-2E.

Each of the fasteners 210 includes a shank, some of which is threaded and some of which may be unthreaded. The threaded portion of each shank is referred to herein as a threaded shank 236A, 236B (hereinafter collectively “threaded shanks 236” or generically “threaded shank 236”). One end of each shank terminates with a hooked end 238A, 238B (hereinafter collectively “hooked ends 238” or generically “hooked end 238”). Corresponding ones of the washers 216 and nuts 214 may be installed on and/or mated to the threaded shanks 236.

In operation, the fasteners 210 cooperate with the clip 208 to clamp the clamp 200 to the pile 202. In particular, and as illustrated in, e.g., FIG. 2C, the hooked ends 238 engage one edge of the flange 202A while the clip 208 engages the other edge of the flange 202A to clamp the flange 202A therebetween. The washers 216 and nuts 214 facilitate the clamping action of the fasteners 210 and the clip 208. For example, with the hooked ends 238 and clip 208 engaging opposing edges of the flange 202A and the washers 216 and nuts 214 installed on and/or mated to the threaded shanks 236, the nuts 214 may be tightened to urge the first planar portion 208A of the clip 208 (via the washers 216) against one edge of the flange 202A while simultaneously pulling or urging the hooked ends 238 against the opposing edge of the flange 202A, thereby clamping or squeezing the flange 202A therebetween.

As previously indicated, the self-tapping screw 218 may be configured to electrically and/or mechanically bond the beam 206 to the pile 202. Alternatively or additionally, the self-tapping screw 218 (or another self-tapping screw 218) may be configured to electrically and/or mechanically bond the clip 208 to the pile 202. The self-tapping screw 218 includes a shaft and a head, the shaft configured (e.g., sized) to pass through any of the openings 226 in the beam 206 and/or any openings 234 in the clip 208 with the head oversized compared to the openings 226, 234 to prevent the self-tapping screw 218 from passing all the way through any of the openings 226, 234. The shaft of the self-tapping screw 218 may be self-tapping so that when the self-tapping screw 218 is screwed into, e.g., the pile 202, the self-tapping screw 218 taps its own threaded opening in the pile 202. The self-tapping screw 218 may electrically bond the beam 206 and/or the clip 208 to the pile 202 by, e.g., urging the beam 206 and/or the clip 208 against the pile 202 to electrically couple the beam 206 and/or the clip 208 to the pile 202. The self-tapping screw 218 may mechanically bond the beam 206 and/or the clip 208 to the pile 202 by mechanically coupling the beam 206 and/or the clip 208 to the pile 202. As illustrated, the mechanical bonding provided by the self-tapping screw 218 may prevent or at least inhibit horizontal movement, e.g., in and out of the page in FIG. 2D, of the beam 206 relative to the pile 202 within the beam opening 230. The mechanical bonding may alternatively or additionally prevent or at least inhibit rotational movement of the beam 206 relative to the clip 208; to the extent there is any play in the beam opening 230 between the beam 206 and the clip 208, mechanically bonding the beam 206 to the pile 202 using the self-tapping screw 218 as illustrated in FIGS. 2A-2D may prevent or at least inhibit the beam 206 from rotating relative to the clip 208 within the beam opening 230.

As illustrated, movement resistance of the clamp 200 may be maintained by three points of contact with the pile 202. As used herein, a point of contact broadly includes a single point of contact between two components up to a contact line or patch between two components. The three points of contact include a first point of contact where the hooked end 238A engages the flange 202A, a second point of contact where the hooked end 238B engages the flange 202A, and a third point of contact where the clip 208 engages the flange 202A. The three points of contact between the clamp 200 and the pile 202 may resist movement of the clamp 200 relative to the pile 202.

FIGS. 3A-3E illustrate another example messenger cable clamp 300 (hereinafter “clamp 300”) clamped to the pile 202 to support the messenger cable 204, arranged in accordance with at least one embodiment herein. FIG. 3A is a perspective view of the clamp 300, FIG. 3B is an exploded perspective view of the clamp 300, FIG. 3C is an overhead view of the clamp 300, FIG. 3D is a side view of the clamp 300, and FIG. 2E is an end view of the clamp 300.

The clamp 300 includes all the components of the clamp 200 (such as the beam 206, the clip 208, the fasteners 210, and so on) and further includes fastener 310, nut 314, washer 316, and self-tapping screw 318. The fastener 310, nut 314, washer 316, and self-tapping screw 318 may be respectively similar or identical to, e.g., fasteners 210, nuts 214, washers 216, and self-tapping screw 218. For example, the fastener 310 includes a shaft extending from a hooked end 338 (similar or identical to the hooked ends 238), the shaft including a threaded shank 336 (similar or identical to the shafts 236).

All components of the clamp 300 work in the same or similar manner as the corresponding components in the clamp 200. For example, the distal end of the beam 206 defines the slot 220 to receive and support the messenger cable 204, the pin 212 being inserted through the through holes 222 in the flanges 206A, 206B of the beam 206 to close the opening of the slot 220 and thereby retain therein the messenger cable 204.

In the embodiment of FIGS. 3A-3E, the self-tapping screw 218 electrically and/or mechanically bonds the clip 208 (rather than the beam 206) to the pile 202. In particular, the shaft of the self-tapping screw 218 may be inserted through the opening 234 in the first planar portion 208A of the clip 208 and screwed into the pile 202, the screwing action of the self-tapping screw 218 tapping a threaded opening (not shown in FIGS. 3A-3E) into the pile 202 for the self-tapping screw 218. When sufficiently screwed into the pile 202 through the opening 234 in the clip 208, the self-tapping screw 218 may urge the clip 208 against the pile 202 to electrically bond (e.g., electrically couple) the clip 208 to the pile 202. Alternatively or additionally, the self-tapping screw 218 may mechanically bond the clip 208 to the pile 202 by mechanically coupling the clip 208 to the pile 202. While the clamping action of the clamp 300 on the pile 202 may generally prevent or at least inhibit vertical movement of the clamp 300 relative to the pile 202 (e.g., generally up and down in FIGS. 3A-3B), the mechanical bonding of the clip 208 to the pile 202 provided by the self-tapping screw 218 may further prevent or at least inhibit vertical movement of the clamp 300 relative to the pile 200.

The self-tapping screw 318 functions in a similar manner to the self-tapping screw 218 to electrically and/or mechanically bond the clip 208 and the beam 206. The self-tapping screw 318 includes both a head and a shaft, the shaft of the self-tapping screw 318 being inserted through the opening 234 in the second planar portion 208B of the clip 208 and screwed into the beam 206. The screwing action of the self-tapping screw 318 taps a threaded opening 301 (FIG. 3B) into the beam 206 for the self-tapping screw 318. When sufficiently screwed into the beam 206 through the opening 234 in the clip 208, the self-tapping screw 318 may urge the clip 208 against the beam 206 to electrically bond (e.g., electrically couple) the clip 208 to the beam 206. Alternatively or additionally, the self-tapping screw 318 may mechanically bond the beam 206 to the clip 208 by mechanically coupling the beam 206 to the clip 208. The self-tapping screw 318 may mechanically bond the beam 206 to the clip 208 by mechanically coupling the beam 206 to the clip 208. As illustrated in FIG. 3A, the mechanical bonding provided by the self-tapping screw 318 may prevent or at least inhibit horizontal movement, e.g., side to side in FIG. 3D, of the beam 206 relative to the clip 208 within the beam opening 230. The mechanical bonding may alternatively or additionally prevent or at least inhibit rotational movement of the beam 206 relative to the clip 208; to the extent there is any play in the beam opening 230 between the beam 206 and the clip 208, mechanically bonding the beam 206 to the clip 208 using the self-tapping screw 318 as illustrated in FIGS. 3A-3E may prevent or at least inhibit the beam 206 from rotating relative to the clip 208 within the beam opening 230.

In the illustrated example, the beam 206 is arranged with its length parallel to the web 202B and perpendicular to the flanges 202A of the pile 202. The clip 208 is arranged with the first planar portion 208A parallel and proximate to one of the flanges 202A of the pile 202 (and perpendicular to the web 202B) and the second planar portion 208B perpendicular to the flanges 202A (and parallel to the web 202B).

In operation, the fasteners 210, 310 cooperate with the clip 208 and the beam 206 to clamp the clamp 300 to the pile 202. In particular, the hooked ends 238 engage one edge of one of the flanges 202A, the hooked end 338 engages one edge of the other of the flanges 202A, and the beam 206 in cooperation with the clip 208 engages the other edges of the flanges 202A to clamp the pile 202 therebetween. The washers 216, 316 and nuts 214, 314 facilitate the clamping action of the fasteners 210, the beam 206, and the clip 208. For example, with the hooked ends 238, 338 and beam 206 engaging opposing edges of the flanges 202A and the washers 216, 316 and nuts 214, 314 installed on and/or mated to the threaded shanks 236, 336, the nuts 214, 314 may be tightened to urge the beam 206 (via the washers 216, 316 and/or the clip 208) against the two flanges 202A of the pile 202 while simultaneously pulling or urging the hooked ends 238, 338 against the opposing edges of the flanges 202A, thereby clamping or squeezing the pile 202 therebetween.

As illustrated, movement resistance of the clamp 300 may be maintained by three or more points of contact with the pile 202. The three or more points of contact include first, second, and third points of contact where the hooked ends 238A, 238B, 338 engage the flanges 202A, fourth and fifth points of contact where the flanges 206A, 206B of the beam 206 urge against one of the flanges 202A of the pile 202, and sixth and seventh points of contact where the flanges 206A, 206B of the beam 206 urge against the other of the flanges 202A of the pile 202. The seven points of contact between the clamp 300 and the pile 202 may resist movement of the clamp 300 relative to the pile 202.

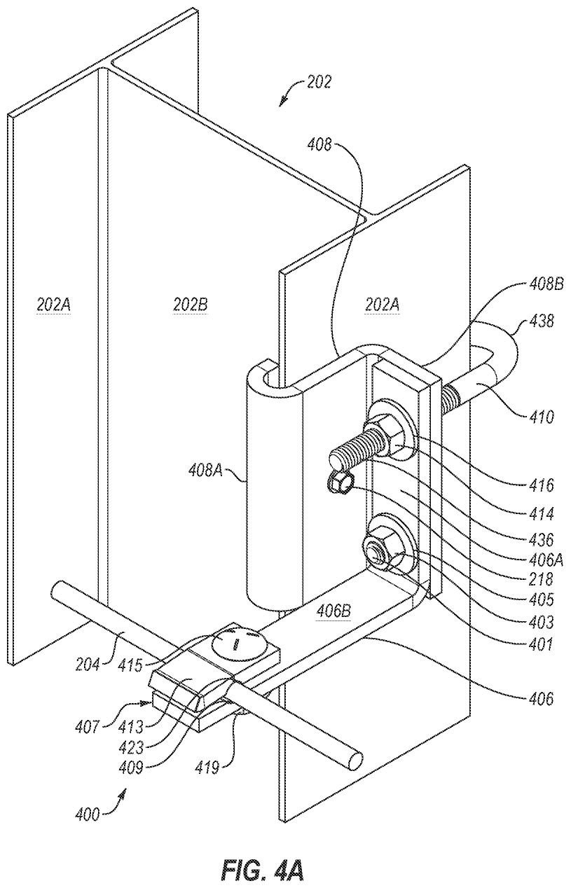

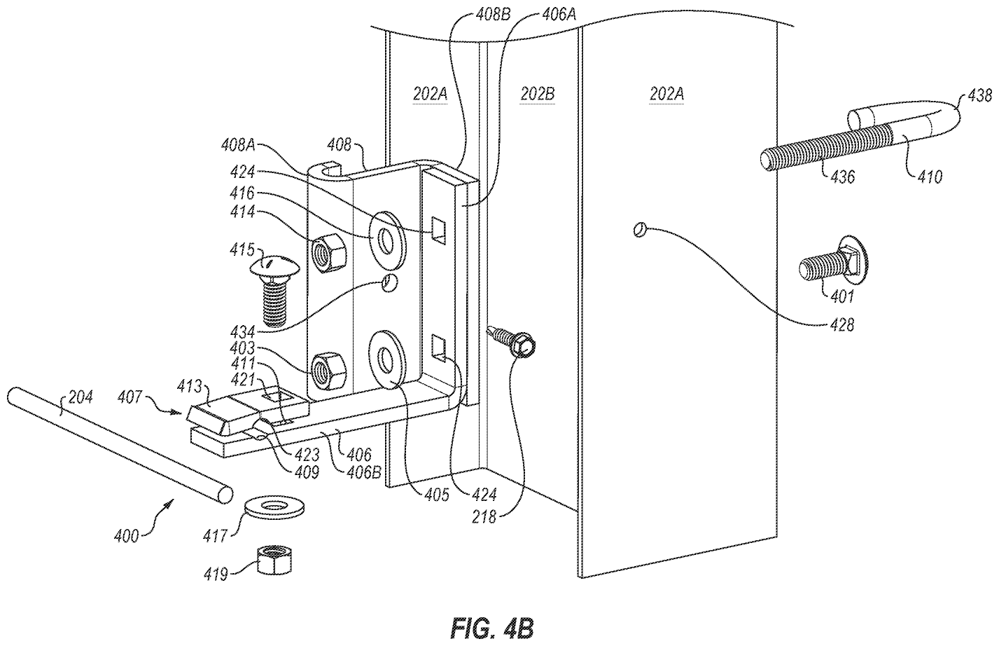

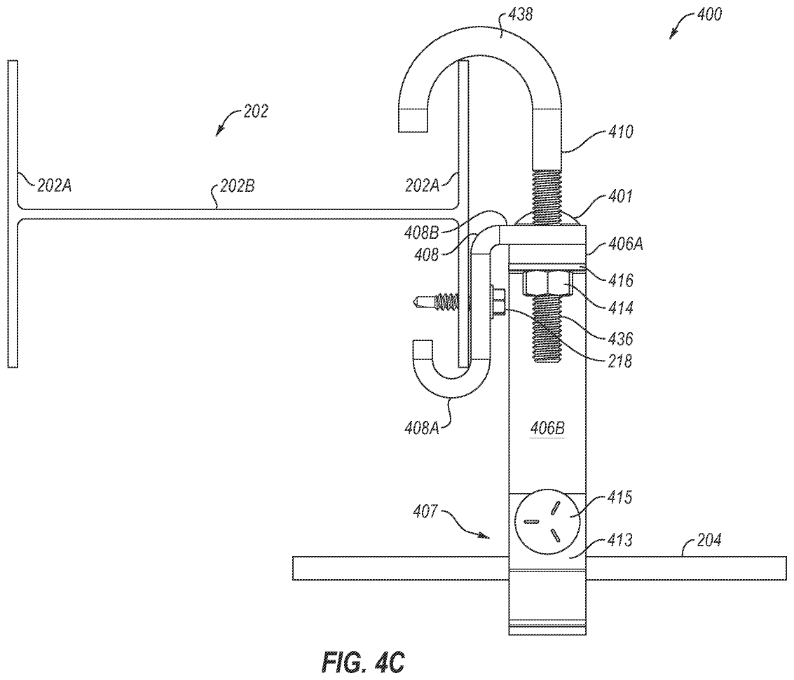

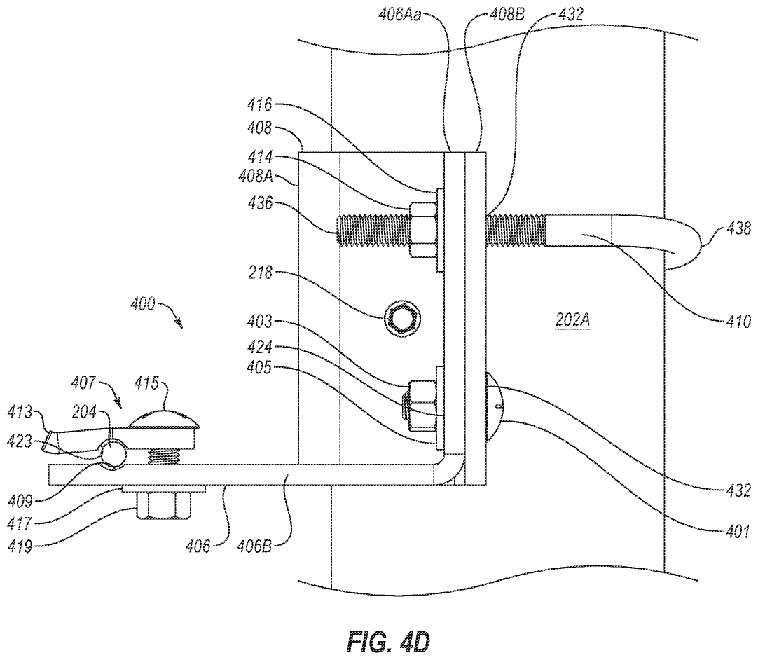

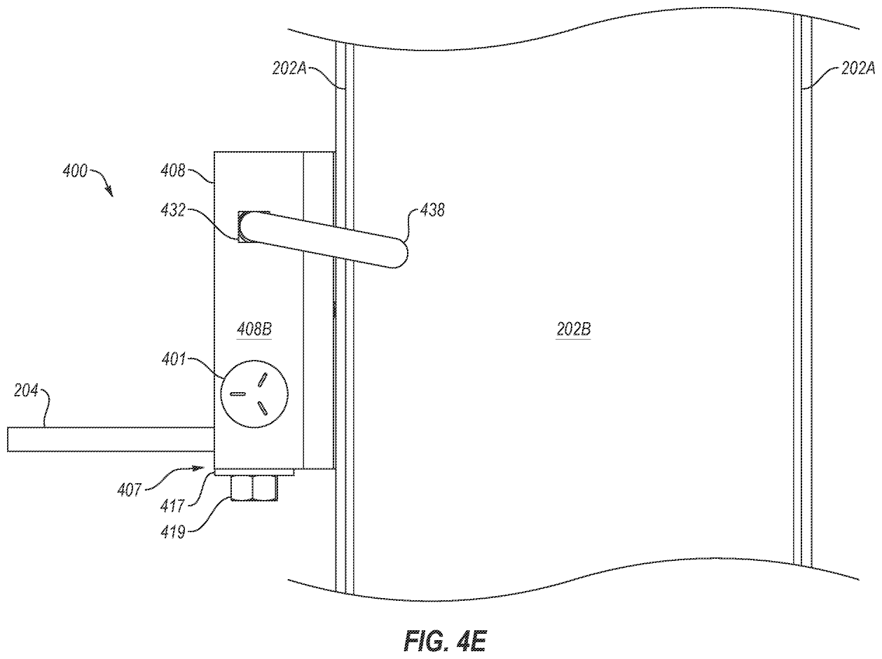

FIGS. 4A-4E illustrate another example messenger cable clamp 400 (hereinafter “clamp 400”) clamped to the pile 202 to support the messenger cable 204, arranged in accordance with at least one embodiment herein. FIG. 4A is a perspective view of the clamp 400, FIG. 4B is an exploded perspective view of the clamp 400, FIG. 4C is an overhead view of the clamp 400, FIG. 4D is a side view of the clamp 400, and FIG. 4E is an end view of the clamp 400.

With combined reference to FIGS. 4A-4E, the clamp 400 includes an elongate clamp beam 406 (hereinafter “beam 406”), a clamp clip 408 (hereinafter “clip 408”), and fastener 410. In some embodiments, the clamp 400 additionally includes one or more of a fastener 401, a nut 403, a washer 405, a retainer 407, a fastener 410, a nut 414, a washer 416, and/or the self-tapping screw 218.

In the illustrated embodiment, the beam 406 includes a first planar portion 406A and a second planar portion 406B. The second planar portion 406B extends away from the first planar portion 406A at an angle, such as perpendicularly in this example. The second planar portion 406B of the beam 406 includes a distal end (e.g., distal from the first planar portion 406A) that defines a channel 409 and/or a through hole 411 (FIG. 4B). The channel 409 may be machined, stamped, pressed, etc. into the second planar portion 406B or formed in some other manner. A depth and size or configuration of the channel 409 may be sufficient to accommodate some or all of a diameter of the cable 204. For example, a depth of the channel 409 and a width of the channel (at the upper surface of the second planar portion 406B, as viewed in FIG. 4D) may be less than, equal to, or greater than the diameter of the cable 204.

The retainer 407 may be coupled to the distal end of the second planar portion 406B of the beam 406 to secure the cable 204 at least partially within the channel 409. In some embodiments, the retainer 407 includes a cable cover 413, a fastener 415, a washer 417, a nut 419, and/or other component(s). The cable cover 413 may define a through hole 421 and/or a channel 423. The channel 423 of the cable cover 413 may be vertically aligned with the channel 409 of the second planar portion 406B of the beam when the through holes 411, 421 are vertically aligned.

The fastener 415 may be a bolt or other fastener. The cable cover 413 may be coupled to the beam 406 by, e.g., inserting the shank of the fastener 415 through both through holes 411, 421 and installing or mating the washer 417 and the nut to the fastener 415. By positioning the cable 204 between the distal end of the second planar portion 406B and the cable cover 413, and particularly within the channels 409, 423 in some embodiments, the cable 204 may be clamped or otherwise secured between the second planar portion 406B and the cable cover 413 by tightening the nut 419 on the fastener 415.

As illustrated, the fastener 415 is a carriage bolt with a portion between a head and threaded shank of the fastener 415 that has a square cross-sectional profile. One or both of the through holes 411, 421 may have a cross-sectional shape that is complementary to (e.g., square) and/or encompasses the square cross-sectional profile of the fastener 415. Rotation of the fastener 415 relative to the cable cover 413 and/or the beam 406 while tightening the nut 419 on the fastener 415 may be prevented or at least inhibited by inserting the shank of the fastener through the through holes 411, 421 to position the portion of the fastener 415 having the square cross-section profile within one or both of the through holes 411, 421.

The clip 408 includes a hooked or wraparound flange 408A and a planar flange 408B, the hooked flange 408A extending away from the planar flange 408B. In some embodiments, the planar flange 408B extends perpendicularly (or at some other angle) from the hooked flange 408A. The hooked flange 408A engages the pile 202, and specifically may engage an edge or other portion of cither of the flanges 202A of the pile 202. For example, a portion of either flange 202A of the pile 202 may be received within the hooked flange 408A of the clip 408.

The first planar portion 406B of the beam 406 may be positioned proximate to the clip 408 when the clamp 400 is assembled. For example, as illustrated, the first planar portion 406B of the beam is positioned proximate to the planar flange 408B of the clip 408. To this end, each of the beam 406 and the clip 408 may define one or more openings 424 (FIGS. 4B, 4D), 432 (FIGS. 4D-4E) therein. In particular, the openings 424 are defined in the first planar portion 406A of the beam 406 and the openings 432 are defined in the planar flange 408B of the clip 408. The openings 424, 432 allow the fasteners 410, 401 (along with nuts 414, 403 and washers 416, 405) to couple the beam 406 to the clip 408.

In the illustrated example, the hooked flange 408A of the clip 408 wraps around and engages one of the flanges 202A of the pile 202. The planar flange 408B is arranged perpendicular to the flange 202A of the pile 202. The beam 406 is arranged with its length perpendicular to the web 202B and parallel to the flanges 202A.

As best seen in FIG. 4B, the clip 408 further defines opening 434. The opening 432, 434 may have different purposes or uses. For example, the larger of the openings, i.e., openings 432, may be configured in some embodiments to have fasteners 410, 401 pass therethrough to secure the clamp 400 to the pile 202, as illustrated in FIGS. 4A-4E. In some embodiments, the smaller of the openings, i.e., the opening 434, may be configured to receive therethrough the self-tapping screw 218 (which is then coupled to the pile 202) to electrically and/or mechanically bond the clip 408 to the pile 202.

Each of the fasteners 410, 401 includes a shank, some of which is threaded and some of which may be unthreaded. The threaded portion of each shank is referred to herein as a threaded shank, e.g., threaded shank 436 in the case of the fastener 410. One end of the shank of the fastener 410 terminates with a hooked end 438. The fastener 401 is illustrated as a carriage bolt terminating with a head and portion between the threaded shank and the head having a square cross-sectional profile. Corresponding ones of the washers 416, 405 and nuts 414, 403 may be installed on and/or mated to the corresponding fastener 410, 401.

In operation, the fastener 401 cooperates with the nut 403 and washer 405 to couple the beam 406 to the clip 408. In particular, after inserting the threaded shank of the fastener 401 through one of the openings 432 of the clip 408 and a corresponding one of the openings 424 of the beam 406, the head of fastener 401 engages the planar flange 408B of the clip 408, the washer is installed on the fastener 401, and the nut is threaded onto the fastener 401 to couple the beam 406 to the clip 408. In this arrangement, the fastener 401, the nut 403, and the washer 405 cooperate to sandwich the planar flange 408B of the clip 408 and the first planar portion 406A of the beam 406 between the head of the fastener 401 and the washer 416.

Moreover, the fastener 410 cooperates with the clip 408 (as well as the nut 414 and washer 416) to clamp the clamp 400 to the pile 202. In particular, and as illustrated in, e.g., FIG. 4C, the hooked end 438 of the fastener 410 engages one edge of the flange 202A while the hooked flange 408A of the clip 408 engages the other edge of the flange 202A to clamp the flange 202A therebetween. The washer 416 and nut 414 facilitate the clamping action of the fastener 410 and the clip 408. For example, with the hooked end 438 and the hooked flange 408A of the clip 408 engaging opposing edges of the flange 202A and the washer 416 and nut 414 installed on and/or mated to the threaded shank 436 of the fastener 410, the nut 414 may be tightened to urge the hooked flange 408A of the clip 408 (via the washer 416, the beam 406, and the planar flange 408B) against one edge of the flange 202A while simultaneously pulling or urging the hooked end 438 against the opposing edge of the flange 202A, thereby clamping or squeezing the flange 202A therebetween.

The self-tapping screw 218 may be configured to electrically and/or mechanically bond the clip 4086 to the pile 202. Alternatively or additionally, the self-tapping screw 218 (or another self-tapping screw 218) may be configured to electrically and/or mechanically bond the beam 406 to the pile 202. The shaft of the self-tapping screw 218 may be configured (e.g., sized) to pass through, e.g., the opening 434 in the clip 408 with the head oversized compared to the opening 434 to prevent the self-tapping screw 218 from passing all the way through the opening 434. The shaft of the self-tapping screw 218 may be self-tapping so that when the self-tapping screw 218 is screwed into, e.g., the pile 202, the self-tapping screw 218 taps its own threaded opening 428 (FIG. 4B) in the pile 202. The self-tapping screw 218 may electrically bond the clip 408 to the pile 202 by, e.g., urging the clip 408 against the pile 202 to electrically couple the clip 408 to the pile 202. The self-tapping screw 218 may mechanically bond the clip 408 to the pile 202 by mechanically coupling the clip 408 to the pile 202. While the clamping action of the clamp 400 on the pile 202 may generally prevent or at least inhibit vertical movement of the clamp 400 relative to the pile 202 (e.g., generally up and down in FIGS. 4A-4B), the mechanical bonding of the clip 408 to the pile 202 provided by the self-tapping screw 218 may further prevent or at least inhibit vertical movement of the clamp 400 relative to the pile 200.

As illustrated, movement resistance of the clamp 400 may be maintained by two points of contact with the pile 202. The two points of contact include a first point of contact where the hooked end 438 engages the flange 202A and a second point of contact where the hooked flange 408A of the clip 408 engages the flange 202A. A third point of contact may be provided by replacing the fastener 401 with another fastener 410 such that both fasteners 410 have a hooked end 438 and cooperate with, e.g., nuts 414, 403 and washers 416, 405 to clamp the pile 202 in the clamp 400. The points of contact between the clamp 400 and the pile 202 (whether two, three, or more points of contact) may resist movement of the clamp 400 relative to the pile 202.

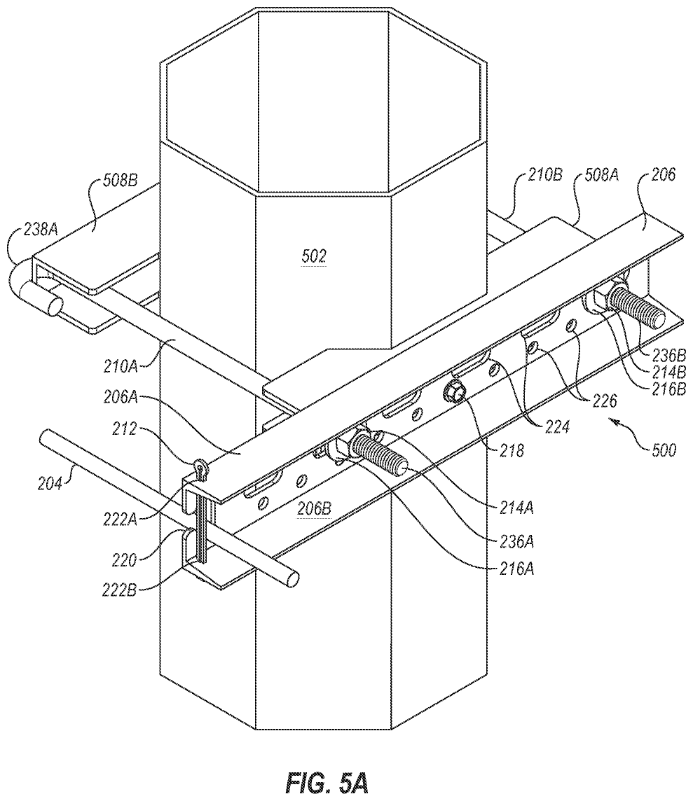

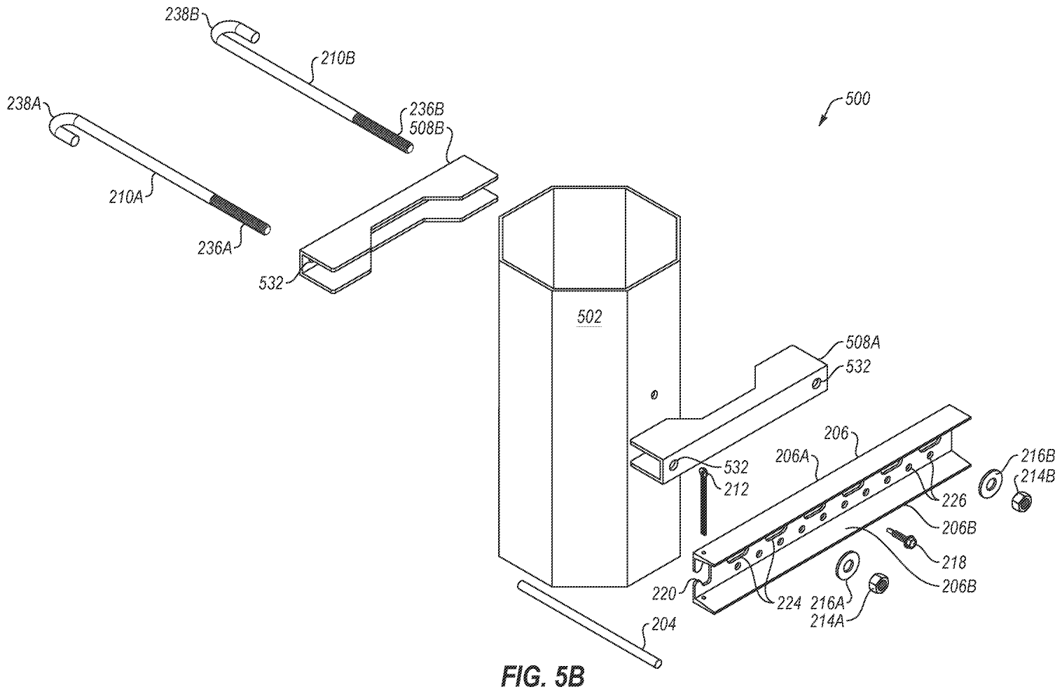

FIGS. 5A-5B illustrate another example messenger cable clamp 500 (hereinafter “clamp 500”) clamped to a pile 502 to support the messenger cable 204, arranged in accordance with at least one embodiment herein. FIG. 5A is a perspective view of the clamp 500 and FIG. 5B is an exploded perspective view of the clamp 500. The clamp 500 includes the beam 206, a first clamp clip 508A (hereinafter “clip 508A”), and the fasteners 210. In some embodiments, the clamp 500 additionally includes one or more of a second clamp clip 508B (hereinafter “second clip 508B”), the nuts 214, the washers 216, and/or the self-tapping screw 218. The beam 206, fasteners 210, nuts 214, and washers 216 operate in the same or similar manner as the beam 206, fasteners 210, nuts 214, and washers 216 in other embodiments herein.

The pile 502 is another example of solar infrastructure to which a clamp as described herein, such as the clamp 500, may be clamped. As illustrated, the pile 502 has an octagonal cross-sectional shape.

The clip 508A defines clip fastener openings 532 (FIG. 5B) that align to two corresponding openings 224 in the beam 206. A center-to-center spacing of the clip fastener openings 532 defined in the clip 508A may be greater than, e.g., slightly greater than, a diameter of the pile 502 such that the fasteners 210 may be arranged parallel to each other on opposite sides of the pile 502 while passing through the clip fastener openings 532 defined in the clip 508A. Thus, the clip fastener openings are configured to receive therethrough the threaded shanks 236 of the fasteners 210, which then pass through the corresponding openings 224 of the beam 206.

The second clip 508B may be configured similar or identical to the clip 508A, the second clip 508B similarly defining clip fastener openings 532 (only one of which is visible and labeled in FIG. 5B). Similar to the clip 508A, a center-to-center spacing of the clip fastener openings 532 defined in the second clip 508B may be greater than, e.g., slightly greater than, a diameter of the pile 502 such that the fasteners 210 may be arranged parallel to each other on opposite sides of the pile 502 while passing through the clip fastener openings 532 defined in the second clip 508B. Thus, the clip fastener openings 532 are configured to receive therethrough the threaded shanks 236 (as well as unthreaded shanks) of the fasteners 210, where the threaded shanks 236 then pass through the corresponding openings of the beam 206.

In the illustrated embodiment, each of the clip 508A and the second clip 508B (hereinafter collectively “clips 508” or generically “clip 508”) has a pile interface arranged to face the pile 502, the pile interface having a complementary shape to the shape of the pile 502. For example, the pile interface of each of the clips 508 may trace a portion of the octagonal cross-sectional shape of the pile 502 such that when mated to the pile 502, the pile interfaces are generally continuously in contact with the pile 508 along sides of the octagonal cross-sectional shape. Such an arrangement may avoid or reduce the likelihood of crushing vertices or a single side of the octagonal cross-sectional shape of the pile 502 if the pile interfaces of the clips 508 were, e.g., planar.

In the illustrated example, the clips 508 are positioned on opposite sides of the pile 502 with the fasteners 510 similarly positioned on opposite sides of the pile 502 that are generally orthogonal to sides of the pile 502 at which the clips 508 are positioned. The threaded shanks 236 of the fasteners 210 are passed through respective ones of the clip fastener openings 532 defined in the second clip 508B, respective ones of the clip fastener openings defined in the clip 508, and then respective ones of the openings 224 (or beam fastener openings) until the hooked ends 238 engage the second clip 508B. With the washers 216 and nuts 214 installed on or mated to a corresponding threaded shaft 236 and the nuts 214 tightened, the pile 502 is sandwiched or clamped between clips 508. With the nuts 214 tightened, the hooked ends 238 engage and pull the second clip 508B against one side of the pile 502, while nuts 214 securely tightened on the threaded shafts 236 of the fasteners 210 urge the washers 216 against the beam 206, which in turn urges the beam 206 against the clip 508A, which in turn urges the clip 508 against the opposite side of the pile 502, thereby clamping or squeezing the pile 502 between the two clips 508.

As illustrated, movement resistance of the clamp 500 may be maintained by three or more points of contact with the pile 502. The three or more points of contact include first and second points of contact where flanges of the second clip 508B engage the pile 502 as well as third and fourth points of contact where flanges of the clip 508A engage the pile 502. The four points of contact between the clamp 500 and the pile 502 may resist movement of the clamp 500 relative to the pile 502.

It will be appreciated, with the benefit of the present disclosure, that the clamps described herein, such as the clamps 112, 200, 300, 400, 500, may clamp to solar infrastructure, such as the pile 104, 202, 502, to support the messenger cable 110, 204 without drilling any pilot holes or through holes in the solar infrastructure. While the clamps herein may (but do not necessarily) include one or more self-tapping screws 218, 318 for electrical and/or mechanical bonding, self-tapping screws may be much easier and less time-consuming to install as they can be installed in a self-tapping manner without requiring the use of a pilot drill bit and a through hole drill bit. As discussed, each of the messenger cable clamps herein (e.g., clamp 112, 200, 300, 400, 500) generally include an elongate clamp beam (e.g., beam 206, 406), one or more clamp clips (e.g., clip(s) 208, 408, 508), and one or more fasteners (e.g., fastener(s) 210, 310, 410) that cooperate to clamp the messenger cable clamp to the solar infrastructure (e.g., pile 202, 502). In some embodiments, the various components of the messenger cable clamp may be adaptable to clamp to a variety of different-shaped components of the solar infrastructure and/or in two or more orientations relative to the components. Some embodiments herein may be quickly clamped to solar infrastructure in any of two or more orientations (e.g., FIGS. 2A-2E and FIGS. 3A-3E), providing case of installation. Movement resistance of the messenger cable clamp may be maintained by three points of contact with the solar infrastructure. Alternatively or additionally, the messenger cable clamp may exploit rotational force exerted by the messenger cable load to further secure the messenger cable clamp to the solar infrastructure. In some embodiments, electrical bonding of a grounding wire to the solar infrastructure may be implemented using a ring terminal or other suitable terminal at any hardware points of the messenger cable clamp (e.g., threaded fastener(s) such as self-tapping screws).

FIGS. 6A-6E illustrate another example messenger cable clamp 600 (hereinafter “clamp 600”) clamped to the pile 202 to support the messenger cable 204, arranged in accordance with at least one embodiment herein. FIG. 6A is a perspective view of the clamp 600, FIG. 6B is an exploded perspective view of the clamp 600, FIG. 6C is an overhead view of the clamp 600, FIG. 6D is a side view of the clamp 600, and FIG. 6E is an end view of the clamp 600.

With combined reference to FIGS. 6A-6E, the clamp 600 includes the beam 206, clamp clips 608 (hereinafter “clips 608”), and fasteners 610A, 610B (hereinafter collectively “fasteners 610” or generically “fastener 610”). In some embodiments, the clamp 600 additionally includes one or more of a retention plate 601, nuts 614A, 614B, 614C, 614D (hereinafter collectively “nuts 614” or generically “nut 614”), washers 616A, 616B, 616C, 616D (hereinafter collectively “washers 616” or generically “washers 616”), and/or the self-tapping screw 218.

Each clip 608 includes a hooked or wraparound flange 608A and a planar flange 608B, the hooked flange 608A extending away from the planar flange 608B. In some embodiments, the planar flange 608B extends perpendicularly (or at some other angle) from the hooked flange 608A. The hooked flange 608A of each clip 608 engages the pile 202, and specifically may engage a corresponding edge or other portion of a corresponding one of the flanges 202A of the pile 202. For example, a portion of either flange 202A of the pile 202 may be received within the hooked flanges 608A of the clips 608 where the clips 608 are positioned on opposite edges of the same flange 202A.

The planar flange 608B of each clip 608 defines a corresponding beam opening 630 that has a shape. The shape of the beam opening 630 is configured to encompass a cross-sectional shape of the beam 206 in a plane perpendicular to a length of the beam 206. Accordingly, the cross-sectional shape of the beam 206 in the plane perpendicular to the length of the beam 206 is encompassed by the cross-sectional shape of the beam openings 630. The beam openings 630 thereby substantially confine the beam 206 in a plane parallel to the web 202B of the pile 202 while permitting movement of the beam 206 relative to the clips 608 in a direction perpendicular to the web 202B of the pile.

The two clips 608 are coupled together to thereby clamp the flange 202A of the pile 202 therebetween using the fasteners 610, nuts 614, and washers 616. To this end, the clips 608 may each define one or more openings 632 therein. In particular, the openings 632 are defined in the planar flange 608B of each clip 608. The openings 632 allow the fasteners 610 (along with nuts 614 and washers 616) to couple the clips 608 together.

In the illustrated example, the hooked flanges 608A of the clips 608 wrap around and engage opposing edges of one of the flanges 202A of the pile 202. The planar flanges 608B of the clips 608 are arranged perpendicular to the flange 202A of the pile 202. The beam 406 is arranged with its length perpendicular to the web 202B and parallel to the flanges 202A. Similar to, e.g., FIGS. 2A-2E, in FIGS. 6A-6E, one of the openings 226 may be configured to receive therethrough the self-tapping screw 218 (which is then coupled to the pile 202) to electrically and/or mechanically bond the beam 206 to the pile 202.

Each of the fasteners 610 includes a threaded shank. While illustrated as threaded along its entire length, the shank of each fastener 610 may instead include one or more unthreaded sections, such as an unthreaded section positioned between two threaded ends. In the illustrated configuration, corresponding ones of the washers 616 and nuts 414 may be installed on and/or mated to ends of the fasteners 410 to couple the clips 608 together.

The retention plate 601 defines openings 603 configured to align to the openings 632 defined in the rearmost clip 608 in FIGS. 6A-6B. When thus aligned and coupled to the rearmost clip 608 (e.g., using fasteners 610), a retaining portion 605 of the retention plate 601 partially blocks the opening 630 formed in the planar flange 608B of the rearmost clip 608. With the retention plate 601 coupled to the rearmost clip 608 in this manner, the opening 630 as reduced by the retention plate 601 no longer encompasses the cross-sectional shape of the beam 206 such that the beam 206 would be unable to enter or pass through the opening 630. However, the notches 201 formed in the flanges 206A, 206B of the beam 206 have a depth sufficient to accommodate therein the retaining portion 605 of the retention plate 601. Thus, prior to coupling the retention plate 601 to the rearmost clip 608, the beam 206 may be positioned inside the opening 630 of the rearmost clip 608. The beam 206 may be aligned relative to the rearmost clip 608 so that the notches 201 are behind the planar flange 608B of the rearmost clip 608. In this arrangement, the retention plate 601 may be positioned with the retaining portion 605 of the retention plate 601 received within the notches 201. The retention plate 601 may then be coupled to the rearmost clip 608 (e.g., using fasteners 610, nuts 614, and/or washers 616), thereby confining movement of the beam 206 relative to the rearmost clip 608 in a direction parallel to the length of the beam 206.

In operation, the fasteners 610 cooperate with the clips 608 (as well as the nuts 614 and washers 616) to clamp the clamp 600 to the pile 202. In particular, and as illustrated in, e.g., FIG. 6C, the hooked flanges 608A of the clips 608 engage opposing edges of the flange 202A to clamp the flange 202A therebetween. The washers 616 and nuts 614 facilitate the clamping action of the fasteners 610 and the clips 608. For example, with the hooked flanges 608A of the clips 608 engaging opposing edges of the flange 202A and the washers 616 and nuts 614 installed on and/or mated to the threaded shanks of the fasteners 610, the nuts 614 may be tightened to simultaneously pull or urge the hooked flanges 608A of the clips 608 (via the washers 616 and the planar flange 608B) against the opposing edges of the flange 202A, thereby clamping or squeezing the flange 202A therebetween.

The self-tapping screw 218 may be configured to electrically and/or mechanically bond the beam 206 to the pile 202. Alternatively or additionally, the self-tapping screw 218 (or another self-tapping screw 218) may be configured to electrically and/or mechanically bond the clips 608 to the pile 202. As described elsewhere herein, the shaft of the self-tapping screw 218 may be configured (e.g., sized) to pass through, e.g., the openings 226 in the clip 608 with the head oversized compared to the openings 226 to prevent the self-tapping screw 218 from passing all the way through the openings 226. The shaft of the self-tapping screw 218 may be self-tapping so that when the self-tapping screw 218 is screwed into, e.g., the pile 202, the self-tapping screw 218 taps its own threaded opening 228 (FIG. 6B) in the pile 202. The self-tapping screw 218 may electrically bond the beam 206 to the pile 202 by, e.g., urging the beam 206 against the pile 202 to electrically couple the beam 206 to the pile 202. The self-tapping screw 218 may mechanically bond the beam 206 to the pile 202 by mechanically coupling the beam 206 to the pile 202. While the clamping action of the clamp 600 on the pile 202 may generally prevent or at least inhibit vertical movement of the clamp 600 relative to the pile 202 (e.g., generally up and down in FIGS. 6A-6B), the mechanical bonding of the beam 206 to the pile 202 provided by the self-tapping screw 218 may further prevent or at least inhibit vertical movement of the clamp 600 relative to the pile 200.

As illustrated, movement resistance of the clamp 600 may be maintained by two points of contact with the pile 202. The two points of contact include a point of contact where one of the hooked flanges 608A of the rearmost clip 608 engages one edge of the flange 202A and a second point of contact where the other hooked flange 608A of the other clip 608 engages the flange 202A. The points of contact between the clamp 600 and the pile 202 (whether two, three, or more points of contact) may resist movement of the clamp 600 relative to the pile 202.

Unless specific arrangements described herein are mutually exclusive with one another, the various implementations described herein can be combined to enhance system functionality or to produce complementary functions. Likewise, aspects of the implementations may be implemented in standalone arrangements. Thus, the above description has been given by way of example only and modification in detail may be made within the scope of the present invention.

With respect to the use of substantially any plural or singular terms herein, those having skill in the art can translate from the plural to the singular or from the singular to the plural as is appropriate to the context or application. The various singular/plural permutations may be expressly set forth herein for sake of clarity. A reference to an element in the singular is not intended to mean “one and only one” unless specifically stated, but rather “one or more.” Moreover, nothing disclosed herein is intended to be dedicated to the public regardless of whether such disclosure is explicitly recited in the above description.

In general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). Furthermore, in those instances where a convention analogous to “at least one of A, B, and C, etc.” is used, in general, such a construction is intended in the sense one having skill in the art would understand the convention (e.g., “a system having at least one of A, B, and C” would include but not be limited to systems that include A alone, B alone, C alone, A and B together, A and C together, B and C together, or A, B, and C together, etc.). Also, a phrase presenting two or more alternative terms, whether in the description, claims, or drawings, should be understood to include one of the terms, either of the terms, or both terms. For example, the phrase “A or B” will be understood to include the possibilities of “A” or “B” or “A and B.”

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A messenger cable clamp, comprising:
an elongate clamp beam;
a clamp clip defining at least a first clip fastener opening and a second clip fastener opening; and
a plurality of fasteners, wherein:
the plurality of fasteners includes at least a first fastener and a second fastener;
the first fastener comprises a first portion configured to pass through the first clip fastener opening in the clamp clip;
the second fastener comprises a second portion configured to pass through the second clip fastener opening in the clamp clip;
at least one of the first or second fasteners is configured to cooperate with one or both of the clamp clip or the elongate clamp beam to clamp the messenger cable clamp to a structural element of solar infrastructure.

2. The messenger cable clamp of claim 1, wherein the at least one of the first or second fasteners is configured to cooperate with one or both of the clamp clip or the elongate clamp beam to clamp the messenger cable clamp to the structural element without passing through the structural element.

3. The messenger cable clamp of claim 1, wherein:
the elongate clamp beam has a cross-sectional shape in a plane perpendicular to a length of the elongate cable beam; and
the clamp clip defines a beam opening have a shape that encompasses the cross-sectional shape of the elongate clamp beam, the elongate clamp beam configured to be positioned within the beam opening of the clamp clip.

4. The messenger cable clamp of claim 3, wherein:
the clamp clip comprises first and second planar portions, the first planar portion arranged perpendicular to the second planar portion;
the beam opening is defined exclusively in the first planar portion; and
the structural element comprises a pile having two parallel flanges coupled together by a web.

5. The messenger cable clamp of claim 4, wherein:
the elongate clamp beam is configured to be arranged with its length parallel to the web and perpendicular to the flanges of the pile; and
the clamp clip is configured to be arranged with the first planar portion parallel and proximate to one of the flanges of the pile and the second planar portion perpendicular to the flanges.

6. The messenger cable clamp of claim 4, wherein:
the elongate clamp beam is configured to be arranged with its length perpendicular to the web and parallel to the flanges of the pile;
the clamp clip is configured to be arranged with the first planar portion perpendicular to the flanges of the pile and the second portion parallel and proximate to one of the flanges of the pile; and
when the messenger cable clamp is coupled to the pile, a portion of one of the flanges of the pile is positioned between the second planar portion of the clamp clip and a portion of the elongate clamp beam.

7. The messenger cable clamp of claim 1, wherein the elongate clamp beam defines a dovetail slot configured to receive therein a messenger cable.

8. The messenger cable clamp of claim 7, further comprising a pin configured to pass through two pin openings defined in the elongate clamp beam to close an opening of the dovetail slot and inhibit egress of the messenger cable from the dovetail slot.

9. The messenger cable clamp of claim 1, wherein:
the first fastener further comprises a first hooked end configured to engage the structural support;
the first portion of the first fastener comprises a first threaded shank configured to mate with a first threaded nut positioned on an opposite side of the clamp clip from the first hooked end;
the second fastener further comprises a second hooked end configured to engage the structural support; and
the second portion of the second fastener comprises a second threaded shank configured to mate with a second threaded nut positioned on an opposite side of the clamp clip from the second hooked end.

10. The messenger cable clamp of claim 1, further comprising a self-tapping bonding screw comprising a shank configured to pass through at least one of the elongate clamp beam or the clamp clip and engage the structural element.

11. The messenger cable clamp of claim 10, wherein the self-tapping bonding screw is configured to at least one of:
electrically bond the elongate clamp beam or the clamp clip to the structural element; or
inhibit rotational movement or horizontal movement of the messenger cable clamp under load relative to the structural element.

12. The messenger cable clamp of claim 1, wherein:
the clamp clip comprises a first clamp clip;
the messenger cable clamp further comprises a second clamp clip that is substantially identical to the first clamp clip;
the second clamp clip is configured to be positioned on an opposite side of the structural element from the first clamp clip;
the second clamp clip defines a third clip fastener opening and a fourth clip fastener opening;
the first portion of the first fastener is further configured to pass through the third clip fastener opening in the second clamp clip followed by passing through the first clip fastener opening in the first clamp clip and then a first beam fastener opening in the elongate clamp beam; and
the second portion of the second fastener is further configured to pass through the fourth clip fastener opening in the second clamp clip followed by passing through the second clip fastener opening in the first clamp clip and then a second beam fastener opening in the elongate clamp beam.

13. The messenger cable clamp of claim 12, wherein the structural element has an octagonal cross-sectional shape.

14. The messenger cable clamp of claim 1, wherein:
the clamp clip comprises a planar flange and a wraparound flange extending from the planar flange, the wraparound flange configured to engage the structural element; and
the elongate clamp beam comprises a first planar portion coupled to the planar flange of the clamp clip, a second planar portion extending away from the first planar portion, and a retainer coupled to a distal end of the second planar portion, the retainer configured to cooperate with the second planar portion to clamp a messenger cable.

15. The messenger cable clamp of claim 1, wherein the clamp clip comprises:
a hooked flange configured to receive within the hooked flange either of two flanges of the structural element; and
a planar flange extending perpendicularly away from an end of the hooked flange, the first and second clip fastener openings being defined in the planar flange of the clamp clip.

16. The messenger cable clamp of claim 1, wherein the elongate clamp beam comprises:
a first planar portion configured to be positioned proximate to the clamp clip;
a second planar portion extending perpendicularly away from the first planar portion, the second planar portion including a first channel defined in a distal end of the second planar portion; and
a retainer configured to be coupled to the distal end of the second planar portion, the retainer comprising a second channel defined therein, the second channel configured to be vertically aligned with the first channel when the retainer is coupled to the distal end of the second planar portion,
wherein the messenger cable is configured to be positioned between the distal end of the second planar portion and the retainer and partially within each of the first and second channels.

17. A messenger cable clamp, comprising:
an elongate clamp beam defining a plurality of openings, the elongate clamp beam having a cross-sectional shape in a plane perpendicular to a length of the elongate clamp beam;
a clamp clip defining a beam opening having a shape that encompasses the cross-sectional shape of the elongate clamp beam, the elongate clamp beam configured to be positioned within the beam opening of the clamp clip, the clamp clip further defining a fastener opening; and
a fastener comprising a first end configured to engage a structural element of a solar infrastructure and an opposing second end configured to pass through the fastener opening of the clamp clip, the fastener configured to cooperate with one or both of the clamp clip or the elongate clamp beam to clamp the messenger cable clamp to the structural element without passing through the structural element.

18. The messenger cable clamp of claim 17, wherein the structural element comprises a pile having two parallel flanges coupled together by a web and wherein the fastener is configured to cooperate with one or both of the clamp clip or the elongate clamp beam to clamp the messenger cable clamp to the pile with the elongate clamp beam arranged parallel to the flanges in a first configuration and with the elongate clamp beam arranged perpendicular to the flanges in a second configuration.

19. The messenger cable clamp of claim 17, wherein the elongate clamp beam includes a distal end relative to the structural element, the distal end defining a slot to receive a messenger cable.

20. The messenger cable clamp of claim 19, further comprising a slot closure configured to block an opening of the slot to retain the messenger cable within the slot.

21. The messenger cable clamp of claim 17, further comprising a self-tapping bonding screw comprising a shank configured to pass through at least one of the elongate clamp beam or the clamp clip and engage the structural element.

22. The messenger cable clamp of claim 21, wherein the self-tapping bonding screw is configured to at least one of:
electrically bond the elongate clamp beam or the clamp clip to the structural element; or
inhibit vertical movement or horizontal movement of the messenger cable clamp under load relative to the structural element.
